(19) United States
(12) Patent Application Publication
(10) Pub. No.: US 2024/0082722 A1
(43) Pub. Date: Mar. 14, 2024

(54) STORAGE MEDIUM, INFORMATION PROCESSING SYSTEM, INFORMATION PROCESSING APPARATUS, AND INFORMATION PROCESSING METHOD

(71) Applicant: NINTENDO CO., LTD., Kyoto (JP)

(72) Inventors: Yuya SATO, Kyoto (JP); Yosuke SAKOOKA, Kyoto (JP)

(21) Appl. No.: 18/241,013

(22) Filed: Aug. 31, 2023

(30) Foreign Application Priority Data
Sep. 12, 2022 (JP) 2022-144908

(51) Int. Cl. A63F 13/56; A63F 13/42; A63F 13/537

(52) U.S. Cl. CPC A63F 13/56; A63F 13/42; A63F 13/537; A63F 13/837

(57) ABSTRACT

An example of an information processing system moves a player character in accordance with an operation input provided by a player, causes the player character to make a remote attack based on a second operation input, and automatically moves a first non-player character. The example of the information processing system, if the player character comes close to the first non-player character, generates a determination area in accordance with an operation input provided by the player and expands the determination area in accordance with a lapse of time, and if the remote attack of the player character hits an object in the determination area, produces a first effect at a position hit by the remote attack.

### CROSS REFERENCE TO RELATED APPLICATION

This application claims priority to Japanese Patent Application No. 2022-144908 filed on Sep. 12, 2022, the entire contents of which are incorporated herein by reference.

### FIELD

An exemplary embodiment relates to a non-transitory computer-readable storage medium having stored therein a game program, an information processing system, an information processing apparatus, and an information processing method that are capable of performing a game where a player character is moved in a virtual space and caused to perform an attack action.

### BACKGROUND AND SUMMARY

Conventionally, there is a game where at least one player character can make a plurality of types of attacks. For example, in the conventional game, the player character makes a special attack and a normal attack.

However, in a game where a player character is caused to make a remote attack, there is room for improvement in maintaining the balance of the game in a case where an effect related to the remote attack is produced.

Therefore, it is an object of an exemplary embodiment to provide a non-transitory computer-readable storage medium having stored therein a game program, an information processing system, an information processing apparatus, and an information processing method that are capable of, in a game where a player character is caused to make a remote attack, maintaining the balance of the game and producing an effect related to the remote attack.

To achieve the above object, the exemplary embodiment employs the following configurations.

(First Configuration)

Instructions according to a first configuration, when executed, cause a processor of an information processing apparatus to execute game processing including controlling a player character to at least move based on a first operation input and make a remote attack based on a second operation input in a virtual space. The game processing also includes generating a determination area in the virtual space in accordance with giving of a predetermined instruction based on an operation input and expanding the determination area in accordance with a lapse of time, and if the remote attack hits an object in the virtual space in the determination area, producing a first effect at a place hit by the remote attack.

Based on the above, if a remote attack of a player character hits an object in a determination area, it is possible to produce a first effect. The determination area is generated in accordance with a predetermined instruction and expanded in accordance with the lapse of time. Thus, even in a case where the first effect is produced in relation to the remote attack, a player does not have an excessive advantage, and it is possible to maintain the balance of the game.

(Second Configuration)

According to a second configuration, in the above first configuration, the game processing may further include automatically controlling a first non-player character in the virtual space. The predetermined instruction may be provision of a third operation input when the player character and the first non-player character have a predetermined positional relationship.

Based on the above, it is possible to produce the first effect in association with a first non-player character.

(Third Configuration)

According to a third configuration, in the above second configuration, the determination area may be generated at a position of the first non-player character.

Based on the above, it is possible to generate the determination area at the position of the first non-player character and associate the first non-player character and the first effect.

(Fourth Configuration)

According to a fourth configuration, in the above third configuration, the determination area may be expanded about the position of the first non-player character.

Based on the above, the determination area is expanded about the first non-player character. Thus, it is possible to cause the player to advance the game while being aware of the position of the first non-player character that is automatically controlled, and it is possible to urge the utilization of the first non-player character.

(Fifth Configuration)

According to a fifth configuration, in any of the above first to fourth configurations, the game processing may further include, if the first effect is produced, erasing the determination area.

Based on the above, if the first effect is produced, the determination area is erased. Thus, it is possible to prevent the first effect from being continuously produced. Thus, it is possible to maintain the balance of the game.

(Sixth Configuration)

According to a sixth configuration, in any of the above first to fifth configurations, the game processing may further include, if a predetermined time elapses after the determination area is generated, or if the determination area is expanded to a predetermined size, erasing the determination area.

Based on the above, if a predetermined time elapses after the determination area is generated, or if the determination area is expanded to a predetermined size, the determination area is erased. Thus, it is possible to somewhat limit the period when the first effect can be produced. Thus, it is possible to maintain the balance of the game.

(Seventh Configuration)

According to a seventh configuration, in the above fifth configuration or sixth configuration, the game processing may further include restricting the generation of the determination area until a predetermined time elapses after the determination area is erased.

Based on the above, until a predetermined time elapses after the determination area is erased, the generation of the determination area is restricted. Thus, for example, it is possible to prevent the first effect from being continuously generated in a short time. Thus, it is possible to maintain the balance of the game.

(Eighth Configuration)

According to an eighth configuration, in any of the above first to seventh configurations, the game processing may further include performing display indicating a range of the determination area.

Based on the above, it is possible to display the range of the determination area. Thus, it is possible to make it easy for the player to make the remote attack by taking aim at the inside of the determination area.

(Ninth Configuration)

According to a ninth configuration, in any of the above first to eighth configurations, the first effect may be an effect of causing damage on an enemy object placed at the place hit by the remote attack, or destroying an obstacle object placed at the place hit by the remote attack.

Based on the above, it is possible to cause damage on an enemy object or destroy an obstacle object as the first effect.

(Tenth Configuration)

According to a tenth configuration, in any of the above second to ninth configurations, the game processing may further include: automatically moving a second non-player character in the virtual space; and if the player character and the second non-player character have a predetermined positional relationship, producing a second effect in accordance with the second operation input.

Based on the above, in a game where an effect is produced in relation to a plurality of non-player characters, if a first non-player character is indicated, an effect is not immediately generated, and the first effect is not generated until the determination area is expanded. Thus, it is possible to spend some time determining a position at which to take aim by the remote attack, or spend some time taking aim.

Another exemplary embodiment may be an information processing system that executes the above game processing, or may be an information processing apparatus, or may be an information processing method executed by an information processing system.

According to the exemplary embodiment, it is possible to maintain the balance of a game and produce an effect related to a remote attack.

These and other objects, features, aspects and advantages of the exemplary embodiments will become more apparent from the following detailed description of the exemplary embodiments when taken in conjunction with the accompanying drawings.

### BRIEF DESCRIPTION OF THE DRAWINGS

FIG. 1 is an example non-limiting diagram showing an exemplary state where a left controller 3 and a right controller 4 are attached to a main body apparatus 2;

FIG. 2 is an example non-limiting block diagram showing an exemplary internal configuration of the main body apparatus 2;

FIG. 3 is an example non-limiting six-sided view showing the left controller 3;

FIG. 4 is an example non-limiting six-sided view showing the right controller 4.

FIG. 5 is an example non-limiting diagram showing an example of a game image displayed on a display 12 or a stationary monitor in a case where a game according to an exemplary embodiment is executed;

FIG. 6 is an example non-limiting diagram showing an example of a game image displayed when a player character 100 is equipped with a bow-and-arrow object;

FIG. 7 is an example non-limiting diagram showing an example of a game image displayed when the player character 100 shoots an arrow object 101;

FIG. 8 is an example non-limiting diagram showing an example of a game image displayed when the player character 100 comes close to a first NPC 110;

FIG. 9 is an example non-limiting diagram showing an example of a game image immediately after an A-button is pressed in FIG. 8;

FIG. 10 is an example non-limiting diagram showing an example of a game image after a predetermined time elapses from the state shown in FIG. 9;

FIG. 11 is a side view of a virtual space and is an example non-limiting diagram illustrating the setting of a determination area;

FIG. 12 is an example non-limiting diagram showing an example of a game image displayed when the player character 100 remotely attacks an enemy character 200 using the bow-and-arrow object in a case where a determination area 120 is set;

FIG. 13 is an example non-limiting diagram showing an example of a game image displayed when the player character 100 shoots the arrow object 101 in the state shown in FIG. 12 and the arrow object 101 hits a ground object;

FIG. 14 is an example non-limiting diagram showing an example of a game image displayed when the player character 100 comes close to the first NPC 110 after FIG. 13;

FIG. 15 is an example non-limiting diagram showing an example of data stored in a memory of the main body apparatus 2 during the execution of game processing;

FIG. 16 is an example non-limiting flow chart showing an example of game processing executed by a processor 81 of the main body apparatus 2;

FIG. 17 is an example non-limiting flow chart showing an example of a player character control process in step S102;

FIG. 18 is an example non-limiting flow chart showing an example of a determination area setting process in step S105; and

FIG. 19 is an example non-limiting flow chart showing an example of a player character attack action process in step S106.

### DETAILED DESCRIPTION OF NON-LIMITING EXAMPLE EMBODIMENTS

(System Configuration)

A game system according to an example of an exemplary embodiment is described below. An example of a game system 1 according to the exemplary embodiment includes a main body apparatus (an information processing apparatus; which functions as a game apparatus main body in the exemplary embodiment) 2, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies. Hereinafter, first, the hardware configuration of the game system 1 according to the exemplary embodiment is described, and then, the control of the game system 1 according to the exemplary embodiment is described.

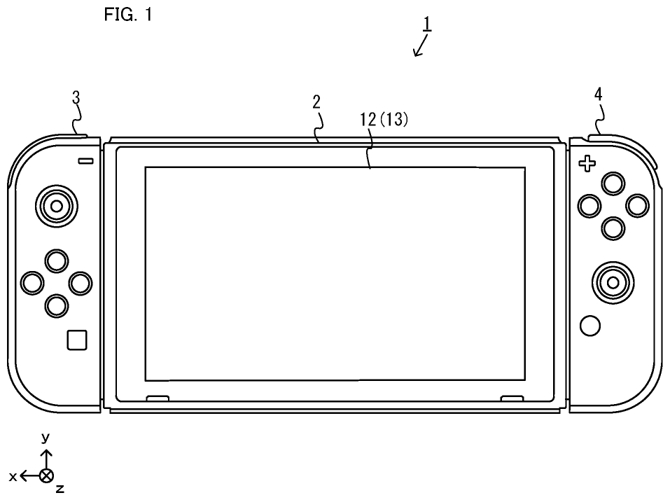

FIG. 1 is a diagram showing an example of the state where the left controller 3 and the right controller 4 are attached to the main body apparatus 2. As shown in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

The left controller 3 and the right controller 4 are attachable to and detachable from the main body apparatus 2. It should be noted that hereinafter, the left controller 3 and the right controller 4 will occasionally be referred to collectively as a “controller”.

The main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus. The main body apparatus 2 or the unified apparatus may function as a portable apparatus.

Further, the main body apparatus 2 includes a touch panel 13 on a screen of the display 12. In the exemplary embodiment, the touch panel 13 is of a type that allows a multi-touch input (e.g., a capacitive type). The touch panel 13, however, may be of any type. For example, the touch panel 13 may be of a type that allows a single-touch input (e.g., a resistive type).

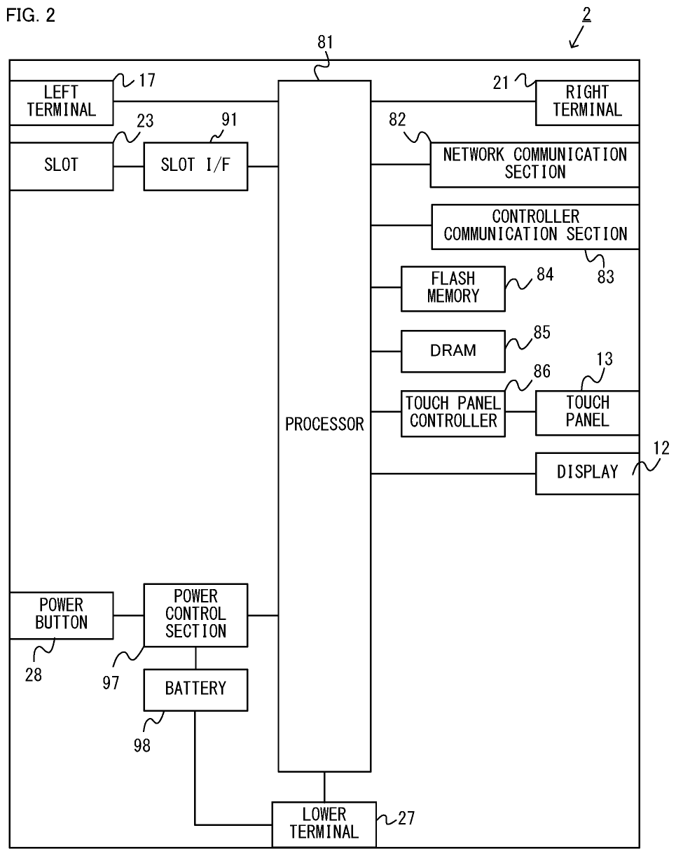

FIG. 2 is a block diagram showing an example of the internal configuration of the main body apparatus 2.

The main body apparatus 2 includes a processor 81. The processor 81 is an information processing section for executing various types of information processing to be executed by the main body apparatus 2. For example, the processor 81 may be composed only of a CPU (Central Processing Unit), or may be composed of an SoC (System-on-a-chip) having a plurality of functions such as a CPU function and a GPU (Graphics Processing Unit) function. The processor 81 executes an information processing program (e.g., a game program) stored in a storage section (specifically, an internal storage medium such as a flash memory 84, an external storage medium attached to the slot 23, or the like), thereby performing the various types of information processing.

The main body apparatus 2 includes a flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing.

The main body apparatus 2 includes a slot interface (hereinafter abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined communication method (e.g., communication based on a unique protocol or infrared light communication).

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2 and the left controller 3 and the right controller 4 is optional. In the exemplary embodiment, the controller communication section 83 performs communication compliant with the Bluetooth (registered trademark) standard with the left controller 3 and with the right controller 4.

The processor 81 is connected to the left terminal 17, the right terminal 21, and the lower terminal 27. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. Further, when communicating with the cradle, the processor 81 transmits data to the cradle via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle, the main body apparatus 2 can output data (e.g., image data or sound data) to the stationary monitor or the like via the cradle.

The main body apparatus 2 includes a touch panel controller 86, which is a circuit for controlling the touch panel 13. The touch panel controller 86 is connected between the touch panel 13 and the processor 81. Based on a signal from the touch panel 13, the touch panel controller 86 generates, for example, data indicating the position where a touch input is provided. Then, the touch panel controller 86 outputs the data to the processor 81.

The main body apparatus 2 includes a power control section 97 and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 17, and the right terminal 21). Based on a command from the processor 81, the power control section 97 controls the supply of power from the battery 98 to the above components.

Further, the battery 98 is connected to the lower terminal 27. When an external charging device (e.g., the cradle) is connected to the lower terminal 27, and power is supplied to the main body apparatus 2 via the lower terminal 27, the battery 98 is charged with the supplied power.

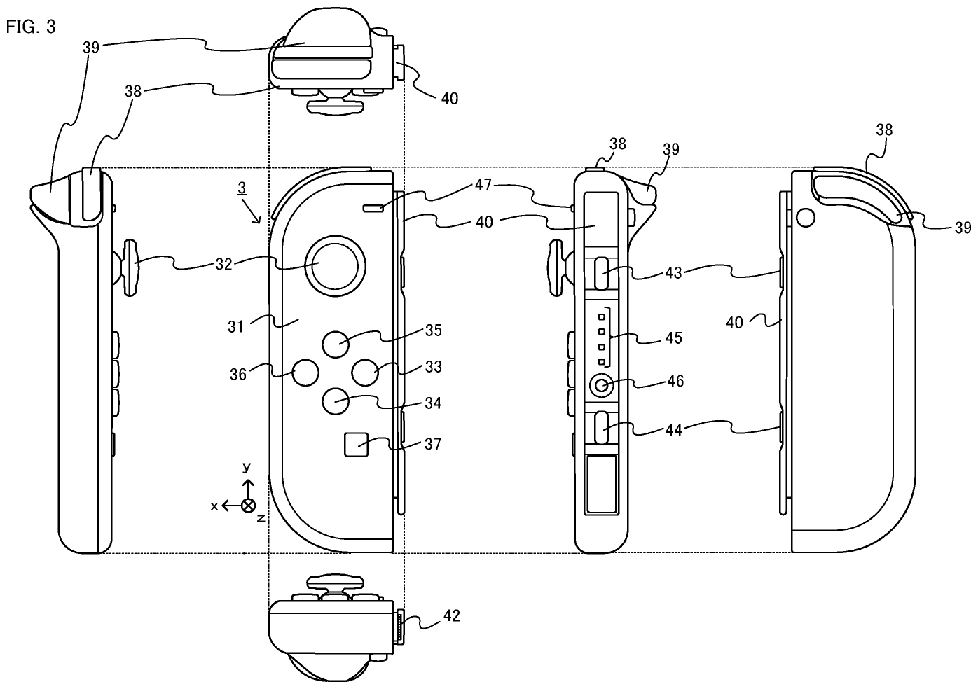

FIG. 3 is six orthogonal views showing an example of the left controller 3. In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly the left hand. Further, the left controller 3 can also be held in the orientation in which the left controller 3 is horizontally long. When held in the orientation in which the left controller 3 is horizontally long, the left controller 3 may be held with both hands.

The left controller 3 includes an analog stick 32. As shown in FIG. 3, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the exemplary embodiment, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an OS program and an application program) executed by the main body apparatus 2.

Further, the left controller 3 includes a terminal 42 for the left controller 3 to perform wired communication with the main body apparatus 2.

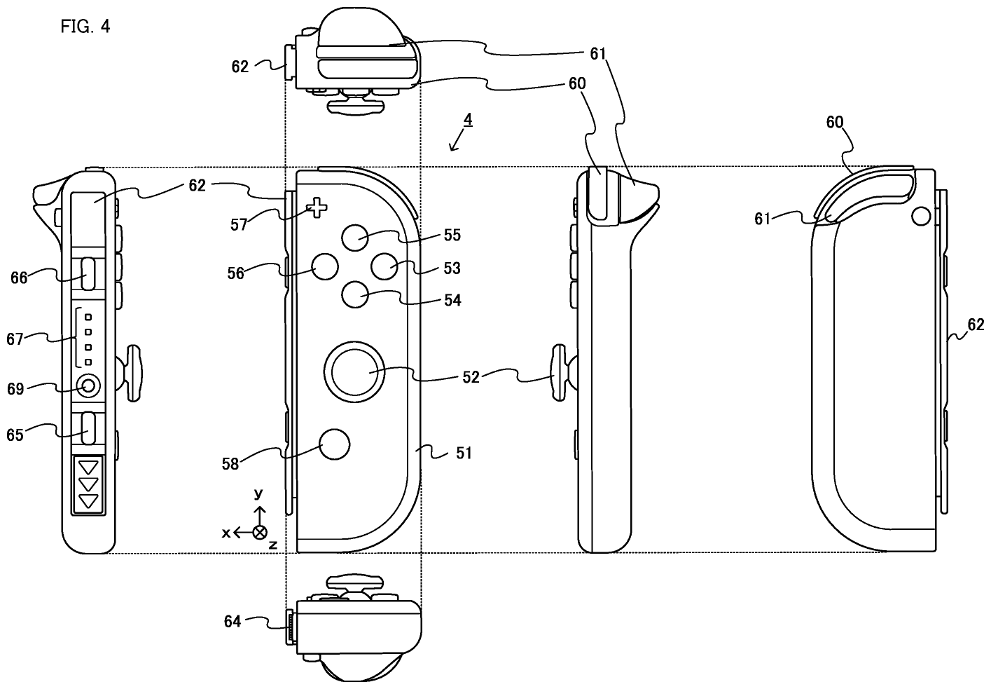

FIG. 4 is six orthogonal views showing an example of the right controller 4. In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes an analog stick 52 as a direction input section. In the exemplary embodiment, the analog stick 52 has the same configuration as that of the analog stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for the right controller 4 to perform wired communication with the main body apparatus 2.

(Overview of Game)

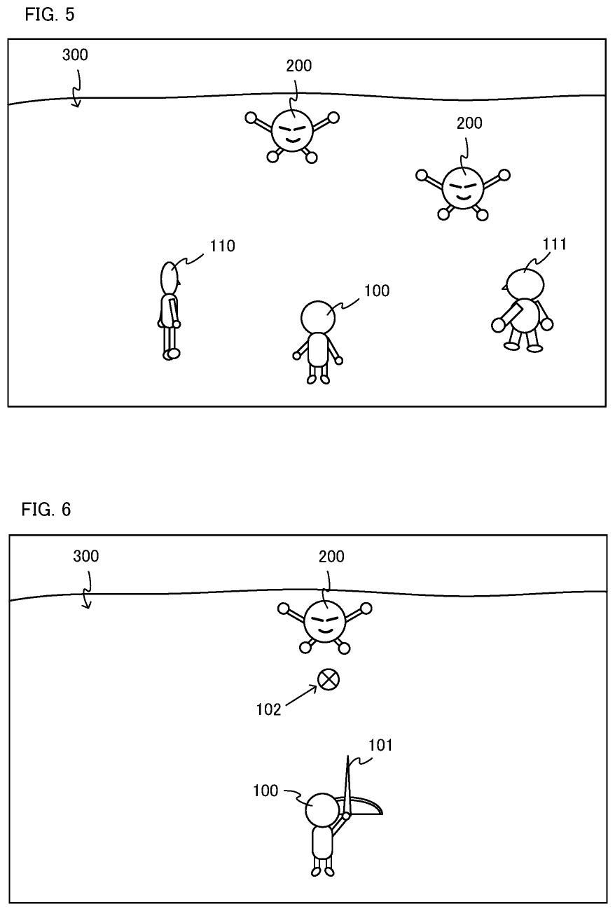

Next, a game according to the exemplary embodiment is described. FIG. 5 is a diagram showing an example of a game image displayed on the display 12 or the stationary monitor in a case where the game according to the exemplary embodiment is executed.

As shown in FIG. 5, a player character 100 and enemy characters 200 are placed in a three-dimensional virtual space (game space). The player character 100 is a character operated by a player, and for example, moves in the virtual space in accordance with an operation on the left analog stick 32. The enemy characters 200 are automatically controlled by the processor 81.

In accordance with an instruction given by the player, the player character 100 performs an attack action. Specifically, the player character 100 can acquire and own a plurality of weapon objects during the progress of the game. The player selects any of the plurality of weapon objects owned by the player character 100 and equips the player character 100 with the weapon object. In accordance with an operation input provided by the player, the player character 100 performs an attack action using the weapon object with which the player character 100 is equipped.

In the game according to the exemplary embodiment, the weapon objects include a bow-and-arrow object with which the player character 100 can make a remote attack. The weapon objects also include a sword object with which the player character 100 can make a proximity attack. Each of the plurality of weapon objects has a different offensive strength in advance. If an attack action is performed using a weapon object having a great offensive strength, and the attack action hits an enemy character 200, great damage is caused on the enemy character 200. If the damage on the enemy character 200 is greater than or equal to a predetermined value, the enemy character 200 falls over.

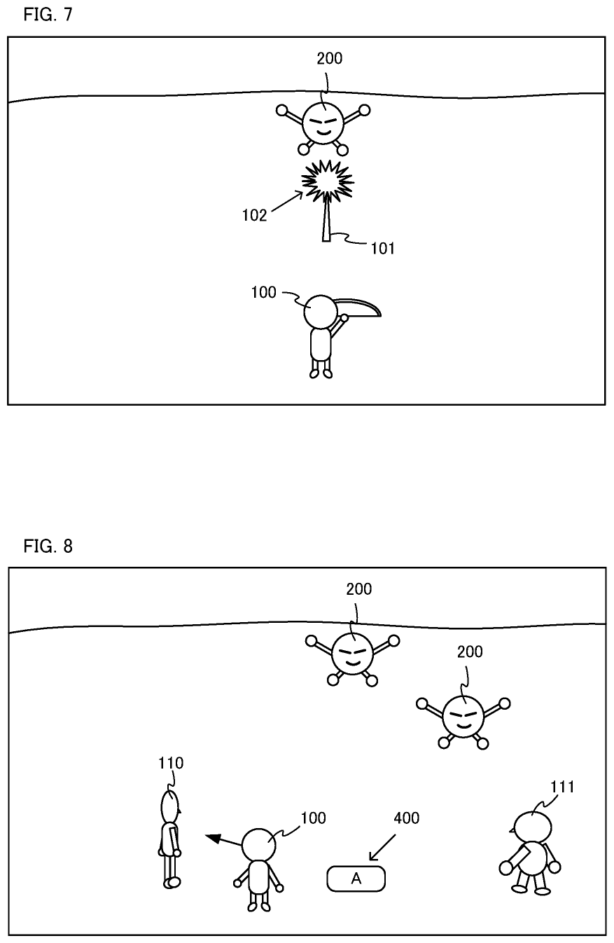

Here, a description is given of the attack of the player character 100 using the bow-and-arrow object. FIG. 6 is a diagram showing an example of a game image displayed when the player character 100 is equipped with the bow-and-arrow object. FIG. 7 is a diagram showing an example of a game image displayed when the player character 100 shoots an arrow object 101.

As shown in FIG. 6, in a case where the player character 100 is equipped with the bow-and-arrow object, and if a predetermined operation input (e.g., the pressing of the ZR-button) is provided by the player, the player character 100 enters a preparation state where the player character 100 holds the arrow object 101 by pulling the arrow object 101. In this preparation state, a target image 102 is displayed. The target image 102 is an image indicating a target to which the arrow object 101 is to fly. For example, the player adjusts the target image 102 to a target using the right analog stick 52. Then, if a shooting instruction (e.g., the pressing of the ZR-button) is given, the arrow object 101 is shot toward a position in the virtual space indicated by the target image 102. In FIG. 6, the target image 102 indicates a position on a ground object 300 on the near side of an enemy character 200. If a shooting instruction is given in this state, as shown in FIG. 7, the arrow object 101 is shot toward the target image 102 and hits the position on the ground object 300 indicated by the target image 102. In this case, the arrow object 101 does not hit the enemy character 200, and therefore, damage is not caused on the enemy character 200. If the arrow object 101 hits the enemy character 200, damage is caused on the enemy character 200.

Referring back to FIG. 5, a first non-player character (hereinafter referred to as “NPC”) 110 and a second non-player character (NPC) 111 are placed in the virtual space. The first NPC 110 and the second NPC 111 are company characters of the player character 100 and are automatically controlled by the processor 81. If the player character 100 moves in the virtual space, the first NPC 110 and the second NPC 111 move by following the player character 100. For example, the first NPC 110 and the second NPC 111 automatically move in the virtual space so as not to separate by a predetermined distance or more from the player character 100. The first NPC 110 and the second NPC 111 also assist the player character 100. For example, the first NPC 110 and the second NPC 111 automatically fight with an enemy character 200 and defeat the enemy character 200.

Each of the first NPC 110 and the second NPC 111 is associated with a unique effect. If the player character 100 comes close to the first NPC 110 or the second NPC 111, the player character 100 becomes able to implement the effect associated with the first NPC 110 or the second NPC 111.

FIG. 8 is a diagram showing an example of a game image displayed when the player character 100 comes close to the first NPC 110. For example, the first NPC 110 and the second NPC 111 automatically move in accordance with the movement of the player character 100. If the player character 100 stops, the first NPC 110 and the second NPC 111 also stop. In this state, the player moves the player character 100 toward the first NPC 110 using the left analog stick 32. As shown in FIG. 8, if the player character 100 comes close to the first NPC 110 (if the distance between the player character 100 and the first NPC 110 becomes less than or equal to a predetermined value), for example, a button image 400 that urges the pressing of the A-button is displayed.

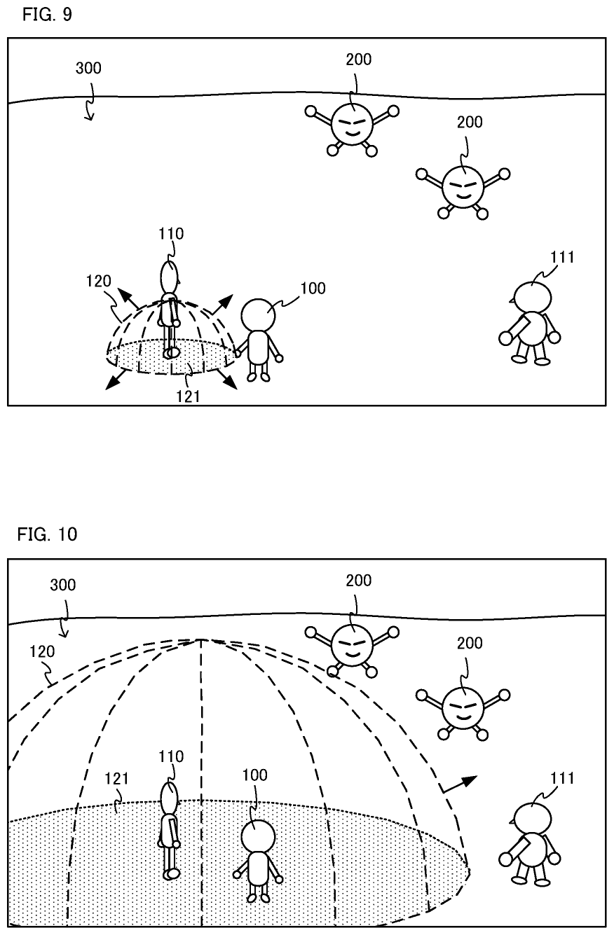

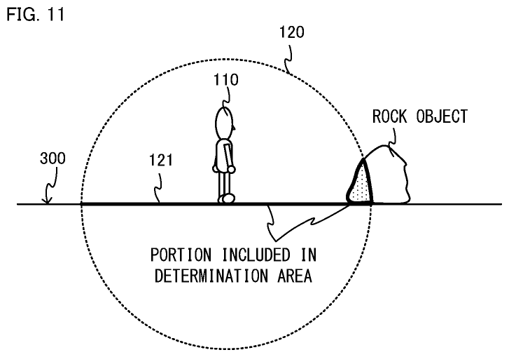

FIG. 9 is a diagram showing an example of a game image displayed immediately after the A-button is pressed in FIG. 8. FIG. 10 is a diagram showing an example of a game image displayed after a predetermined time elapses from the state shown in FIG. 9. FIG. 11 is a side view of the virtual space and is a diagram illustrating the setting of a determination area.

As shown in FIG. 9, if the player character 100 comes close to the first NPC 110 and the A-button is pressed, a determination area 120 centered on the first NPC 110 is generated.

Specifically, as shown in FIG. 11, in accordance with the pressing of the A-button, the spherical determination area 120 is set in the virtual space about the first NPC 110. In FIGS. 9 and 10, only the upper half of the spherical determination area 120 is displayed. For example, the determination area 120 is displayed translucently on the screen. The determination area 120 may be an area that is internally set without being displayed on the screen. For example, in FIG. 11, the first NPC 110 and a rock object are placed on the ground object 300. In the surface of the ground object 300, a portion included in the determination area 120 (a thick-line portion in FIG. 11) changes to a particular display form different from that of a portion that is not included in the determination area 120. In the surface of the rock object, a portion included in the determination area 120 (a portion surrounded by a thick line in FIG. 11) changes to a particular display form different from that of a portion that is not included in the determination area 120. In FIG. 9, a part of the ground object 300 that is a flat surface is included in the determination area 120, and therefore, a circular area on the ground object 300 is displayed in a particular display form different from that of another area. In accordance with the lapse of time, the determination area 120 is expanded. For example, the determination area 120 is expanded by lengthening the radius of the determination area 120 at a certain speed. If a certain time (e.g., 10 seconds) elapses, the expansion of the determination area 120 stops.

If various objects placed in the virtual space are included in the determination area 120, the display forms of the surfaces of the various objects included in the determination area 120 change to particular display forms. For example, if some or all of the enemy characters 200 are included in the determination area 120, the surfaces of the enemy characters 200 included in the determination area 120 change to particular display forms. Hereinafter, portions of objects included in the spherical determination area 120 (a portion changed to a particular display form) are referred to as a “particular display area 121”.

If the first NPC 110 moves, the determination area 120 also moves. Specifically, after the player character 100 comes close to the first NPC 110 and the A-button is pressed, the center of the determination area 120 is set at the position of the first NPC 110. Then, if the player character 100 starts moving, the first NPC 110 also moves by following the player character 100. In accordance with the movement of the first NPC 110, the center of the determination area 120 also moves. That is, even if the first NPC 110 moves, the center of the determination area 120 is set at the position of the first NPC 110. Also while the determination area 120 is expanding, or also after the expansion of the determination area 120 stops, the determination area 120 moves in accordance with the movement of the first NPC 110.

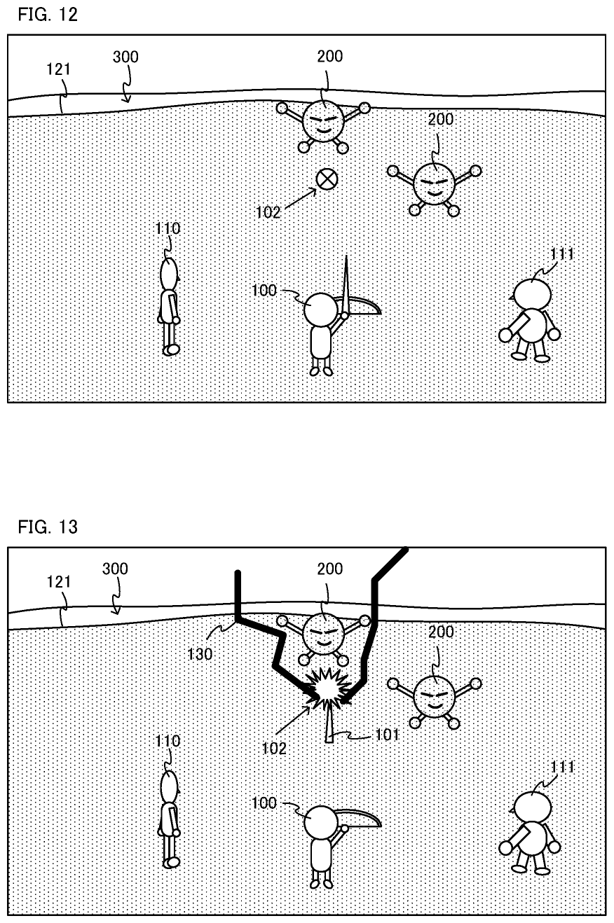

FIG. 12 is a diagram showing an example of a game image displayed when the player character 100 remotely attacks an enemy character 200 using the bow-and-arrow object in a case where the determination area 120 is set. FIG. 13 is a diagram showing an example of a game image displayed when the player character 100 shoots the arrow object 101 in the state in shown in FIG. 12, and the arrow object 101 hits the ground object. In FIGS. 12 and 13, the display of the spherical determination area 120 itself is omitted, and the portions of the objects included in the determination area 120 (the particular display area 121) are displayed.

When the player character 100 is equipped with the bow-and-arrow object, and if a predetermined operation input (e.g., the pressing of the ZR-button) is given by the player, the player character 100 enters a preparation state where the player character 100 holds the arrow object 101 by pulling the arrow object 101. As shown in FIG. 12, the target image 102 is displayed at a position on the ground object 300 on the near side of an enemy character 200 and a position included in the determination area 120.

At this time, if a shooting instruction is given by the player, as shown in FIG. 13, the arrow object 101 hits the position on the ground object 300 indicated by the target image 102, and lightning 130 strikes at the position hit by the arrow object 101. The lightning 130 has the properties of electricity and influences the periphery. Thus, even if the position hit by the arrow object 101 (the position where the lightning 130 strikes) is different from the position of the enemy character 200, damage is caused on the enemy character 200. The magnitude of the damage caused on the enemy character 200 by the lightning 130 may differ depending on the properties of the enemy character 200. For example, the enemy characters 200 include a character having the property of being vulnerable to electricity and a character having the property of being resistant to electricity. The enemy character 200 vulnerable to electricity is greatly damaged by the lightning 130. The magnitude of the damage on the enemy character 200 differs in accordance with the distance from the position where the lightning 130 strikes. For example, the shorter the distance from the position where the lightning 130 strikes is, the greater the damage on the enemy character 200 is.

If the arrow object 101 hits an object (here, the ground object 300) included in the determination area 120 and the lightning 130 strikes at the position hit by the arrow object 101, the determination area 120 is erased, and each object included in the determination area 120 returns to a normal display form. If a predetermined effective period elapses after the determination area 120 is generated, the determination area 120 is erased. For example, if the predetermined effective period elapses after the time when the determination area 120 is generated (the time when the A-button is pressed in FIG. 8), the determination area 120 may be erased. If the predetermined effective period elapses after the time when the expansion of the determination area 120 is stopped, the determination area 120 may be erased.

Even if the determination area 120 is set in the virtual space, but the arrow object 101 hits the surface of an object that is not included in the determination area 120, the lightning 130 is not generated, and the same effect as that when the normal arrow object 101 hits the surface of the object as shown in FIG. 7 is generated. In this case, the determination area 120 is not erased, and the determination area 120 is maintained until the above predetermined effective period elapses.

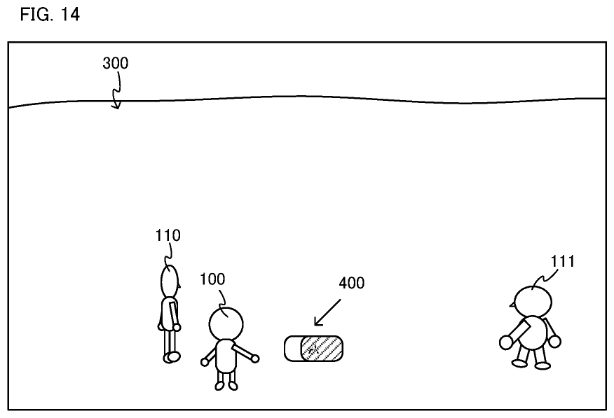

FIG. 14 is a diagram showing an example of a game image displayed when the player character 100 comes close to the first NPC 110 after FIG. 13.

Until the predetermined restriction period (e.g., 10 seconds) elapses after the lightning 130 strikes, the generation of the determination area 120 is restricted. Specifically, as shown in FIG. 14, after the lightning 130 strikes, if the player character 100 moves close to the first NPC 110, the button image 400 changes to a display form indicating that the pressing of the A-button is not enabled. For example, a gauge is displayed in the button image 400, and the gauge extends in accordance with the lapse of time. Even within the predetermined restriction period, the player character 100 can shoot the arrow object 101, but the determination area 120 is not generated. Thus, the lightning 130 does not strike at the position hit by the arrow object 101. If the predetermined restriction period elapses, the gauge of the button image 400 extends to the end, and the pressing of the A-button becomes enabled. Then, if the A-button is pressed, the determination area 120 centered on the first NPC 110 is generated again, and the determination area 120 is expanded in accordance with the lapse of time.

The lightning 130 has the effect of destroying a predetermined object placed in the virtual space in addition to the attack effect on an enemy character 200. For example, in a case where a rock object as an obstacle to the player character 100 is placed in the virtual space, and if the lightning 130 strikes at the position of the rock object or on the periphery of the rock object, the rock object is destroyed. For example, the player character 100 can also destroy the rock object placed in the virtual space using a predetermined item (e.g., a hammer item) owned by the player character 100. The player character 100 may be able to destroy the rock object more easily by using the lightning 130 than by using the predetermined item. For example, the destruction range of the rock object may be larger in a case where the lightning 130 hits the rock object than in a case where the predetermined item hits the rock object. In a case where the lightning 130 hits the rock object, the rock object may be destroyed by the lightning 130 hitting the rock object once, but in a case where the predetermined item hits the rock object, the rock object may be destroyed by the predetermined item hitting the rock object multiple times. The player can destroy any object as an obstacle to the player character 100 in addition to the rock object by causing the lightning 130 to strike.

The lightning 130 also has the effect of causing the periphery to ignite. For example, if there is an object that is likely to ignite (e.g., grass or a tree) on the periphery of the position where the lightning 130 strikes, the object may be caused to ignite.

Although not shown in the figures, if the player character 100 comes close to the second NPC 111, as shown in FIG. 8, the button image 400 urging the pressing of the A-button is displayed. If the A-button is pressed in this state, a second effect associated with the second NPC 111 is produced. “The second effect is produced” means that an effect different from the effect produced when the above lightning 130 strikes (a first effect) is produced. For example, the second effect may be the player character 100 entering the state where the player character 100 can make a predetermined attack, or the second NPC 111 entering the state where the second NPC 111 can make a predetermined attack, or the player character 100 entering the state where the player character 100 is protected from a particular situation.

As described above, in the game according to the exemplary embodiment, the player character 100 moves in the virtual space based on an operation input provided by the player, or for example, makes a remote attack using the bow-and-arrow object based on an operation input provided by the player. In accordance with the fact that a predetermined instruction is given by the player, the determination area 120 is generated in the virtual space, and the determination area 120 is expanded in accordance with the lapse of time. In the exemplary embodiment, the predetermined instruction is the fact that the player character 100 moves close to the first NPC 110 and the A-button is pressed. If the remote attack of the player character 100 hits an object in the determination area 120, the first effect (the effect of the lightning 130) is produced at the place hit by the remote attack (a predetermined range including the position hit by the arrow object 101).

After the determination area 120 is generated, the first effect is generated in accordance with the remote attack. Thus, the player can generate the determination area 120, then take aim for the remote attack, or move and take aim.

Since the determination area 120 is expanded in accordance with the lapse of time, if the player is to produce the first effect by taking aim at a distant position, the player needs to wait until the determination area 120 is expanded. Consequently, it is possible to prevent the player from having an excessive advantage due to the remote attack, and it is possible to maintain the balance of the game. That is, if the player character 100 makes the remote attack, it is possible to cause damage on an enemy character 200 at a position separate from the enemy character 200. Thus, this is an attack method in favor of the player. If the first effect is immediately produced in addition to such a remote attack, the player may have an excessive advantage. In the exemplary embodiment, the determination area 120 is generated in accordance with the predetermined instruction, and the determination area 120 is expanded in accordance with the lapse of time. Thus, it is possible to prevent the player from having an excessive advantage, and it is possible to maintain the balance of the game.

In the exemplary embodiment, after the lightning 130 is generated, the determination area 120 is erased, and the predetermined restriction period when the determination area 120 is not generated is provided. Thus, it is possible to prevent the lightning 130 from being continuously generated in a short time and prevent the player from having an excessive advantage.

In accordance with the fact that the player character 100 moves close to the first NPC 110 and the A-button is pressed, the determination area 120 related to the first NPC 110 is generated. Consequently, the player can advance the game by positively utilizing the first NPC 110 that is automatically controlled. The player character 100 moves close to the first NPC 110, whereby it is possible to produce the first effect in addition to the remote attack. Thus, it is possible to urge the use of the first NPC 110.

In the exemplary embodiment, even if the determination area 120 is not generated, for example, it is possible to produce the effect of fire or electricity in addition to the attack effect of a normal arrow object by shooting a special arrow object to which fire or electricity is added. The effect of the lightning 130 related to the above first NPC 110 is greater than the effect of the arrow object to which electricity is applied. For example, the offensive strength and the destruction force of the lightning 130 related to the first NPC 110 are greater than the offensive strength and the destruction force of the arrow object to which electricity is added.

(Description of Data Used in Game Processing)

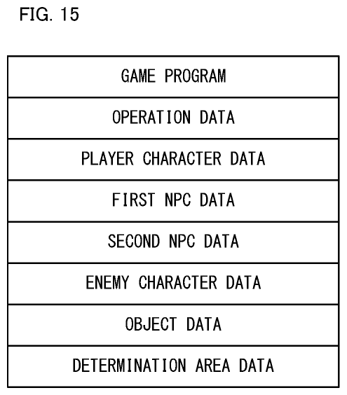

Next, the details of game processing are described. First, data used in the game processing is described. FIG. 15 is a diagram showing an example of data stored in a memory of the main body apparatus 2 during the execution of the game processing.

As shown in FIG. 15, the memory (the DRAM 85, the flash memory 84, or the external storage medium) of the main body apparatus 2 stores a game program, operation data, player character data, first NPC data, second NPC data, enemy character data, object data, and determination area data. As well as these, various pieces of data are stored in the memory.

The game program is a program for executing the game processing described below. The game program is stored in advance in the external storage medium attached to the slot 23 or the flash memory 84, and when the game is executed, is loaded into the DRAM 85. The game program may be acquired from another apparatus via a network (e.g., the Internet).

The operation data is data regarding operations acquired from the left controller 3 and the right controller 4. For example, the operation data includes data relating to operations on the left and right analog sticks and data relating to operations on the buttons. For example, the operation data is transmitted from the left controller 3 and the right controller 4 to the main body apparatus 2 at predetermined time intervals (e.g., 1/200-second intervals) and stored in the memory.

The player character data is data regarding the player character 100 and includes data regarding the position in the virtual space, the direction, the moving direction, the moving velocity, and the like of the player character 100. The player character data also includes the life value of the player character 100. The player character data also includes data regarding the external appearance such as the shape of the player character 100. The player character data also includes owned item data indicating items owned by the player character 100 (weapon objects, a protective gear object, other items used in the game, and the like). The player character data also includes equipment data indicating a weapon object with which the player character 100 is equipped.

The first NPC data is data regarding the above first NPC 110. The first NPC data includes data regarding the position in the virtual space, the direction, the moving direction, the moving velocity, and the like of the first NPC 110. The first NPC data also includes data indicating the external appearance such as the shape of the first NPC 110 and attribute data.

The second NPC data is data regarding the above second NPC 111. The second NPC data includes data regarding the position in the virtual space, the direction, the moving direction, the moving velocity, and the like of the second NPC 111. The second NPC data also includes data indicating the external appearance such as the shape of the second NPC 111 and attribute data. Further, a third NPC and a fourth NPC may be placed in addition to the first NPC 110 and the second NPC 111 in the virtual space. In this case, data regarding the third NPC and data regarding the fourth NPC are stored in the memory.

The enemy character data is data regarding the plurality of enemy characters 200 placed in the virtual space. The enemy character data includes data regarding the position in the virtual space, the direction, the moving direction, the moving velocity, and the like of each enemy character 200. The enemy character data also includes the life value of each enemy character 200. The enemy character data also includes data regarding the external appearance such as the shape of each enemy character 200 and data regarding the attribute of each enemy character 200.

The object data is data regarding objects placed in the virtual space (e.g., a ground object, an obstacle object as an obstacle to the player character 100, and the like). The object data includes data regarding the position in the virtual space of each object. The object data also includes data regarding the external appearance such as the shape of each object and data regarding the attribute of each object.

The determination area data is data regarding the above determination area 120. Specifically, the determination area data includes data indicating whether or not the determination area 120 is set and data regarding the position and the radius of the determination area 120. The determination area data also includes data regarding the time elapsed since the determination area 120 is generated.

(Details of Game Processing Performed by Main Body Apparatus 2)

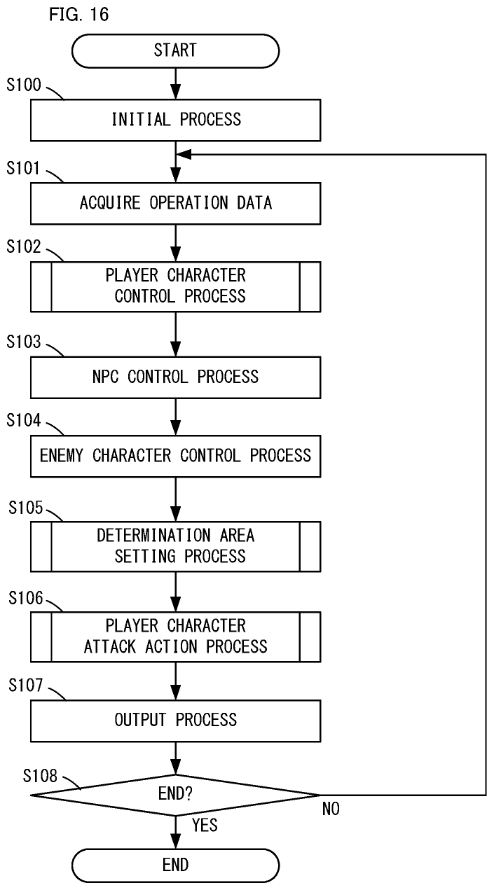

Next, the details of game processing performed by the main body apparatus 2 are described. FIG. 16 is a flow chart showing an example of game processing executed by the processor 81 of the main body apparatus 2.

As shown in FIG. 16, first, the processor 81 executes an initial process (step S100). Specifically, the processor 81 sets the three-dimensional virtual space and places the player character 100, the enemy characters 200, the first NPC 110, the second NPC 111, a virtual camera, and other objects in the virtual space. After executing the initial process, the processor 81 repeatedly executes the processes of subsequent steps S101 to S108 at predetermined frame time intervals (e.g., 1/60-second intervals).

In step S101, the processor 81 acquires operation data from the controllers. The operation data includes data regarding the operation states of the buttons and the analog sticks of the left controller 3, the buttons and the analog sticks of the right controller 4, and the like. In step S101, the processor 81 acquires the operation data transmitted from the controllers and stored in the memory.

Next, the processor 81 performs a player character control process (step S102). Here, for example, the process of moving the player character 100 in the virtual space based on the operation data is performed. In step S102, a process regarding an attack action of the player character is performed. The details of the player character control process in step S102 will be described below.

Next, the processor 81 performs an NPC control process (step S103). Here, the processor 81 moves the first NPC 110 and the second NPC 111 in the virtual space in accordance with a predetermined algorithm and causes the first NPC 110 and the second NPC 111 to perform predetermined actions in the virtual space. For example, the processor 81 automatically controls the position of the first NPC 110 so that the first NPC 110 follows the player character 100. If the player character 100 stops, the processor 81 stops the first NPC 110. The processor 81 also causes the first NPC 110 to perform an action. For example, the processor 81 controls the first NPC 110 to fight with an enemy character 200 as the action. The processor 81 automatically controls the first NPC 110, regardless of whether or not the determination area 120 is set in the virtual space. Similarly, the processor 81 controls the movement and the action of the second NPC 111. Based on these types of control, the processor 81 moves the NPCs by amounts of movement relating to a single frame and advances the animations of the NPCs based on the actions by a single frame.

Next, the processor 81 performs an enemy character control process (step S104). Specifically, the processor 81 moves the enemy characters 200 in the virtual space in accordance with a predetermined algorithm and causes the enemy characters 200 to appear in the virtual space. In accordance with a predetermined algorithm, the processor 81 also causes each enemy character 200 to perform an attack action on the player character 100. For example, if the attack action of an enemy character 200 hits the player character 100, the processor 81 decreases the life value of the player character 100.

Next, the processor 81 performs a determination area setting process (step S105). Here, if the determination area 120 is set in the virtual space, the processor 81 expands the determination area 120 in accordance with the lapse of time. The details of the determination area setting process in step S105 will be described below.

Next, the processor 81 performs a player character attack action process (step S106). Here, based on the operation data, the processor 81 equips the player character 100 with a weapon object or causes the player character 100 to perform an attack action using a weapon object. For example, if the player character 100 is equipped with the bow-and-arrow object, the processor 81 shoots the arrow object 101 based on the operation data. The details of the player character attack action process will be described below.

Next, the processor 81 performs an output process (step S108). Specifically, the processor 81 generates an image of the virtual space relating to the results of the processes of the above steps S102 to S107 using the virtual camera and outputs the generated image to a display apparatus. The processor 81 also outputs a sound with the generation and the output of the image. Consequently, a game image is displayed on the display apparatus, and a sound relating to the game processing is output from a speaker.

Next, the processor 81 determines whether or not the game processing is to be ended (step S108). For example, if the player gives an instruction to end the game, the processor 81 determines that the game processing is to be ended (step S108: YES). Then, the processor 81 ends the game processing shown in FIG. 16. If the processor 81 determines that the game processing is not to be ended (step S108: NO), the processor 81 executes the process of step S101 again. This is the description of the game processing shown in FIG. 16.

(Player Character Control Process)

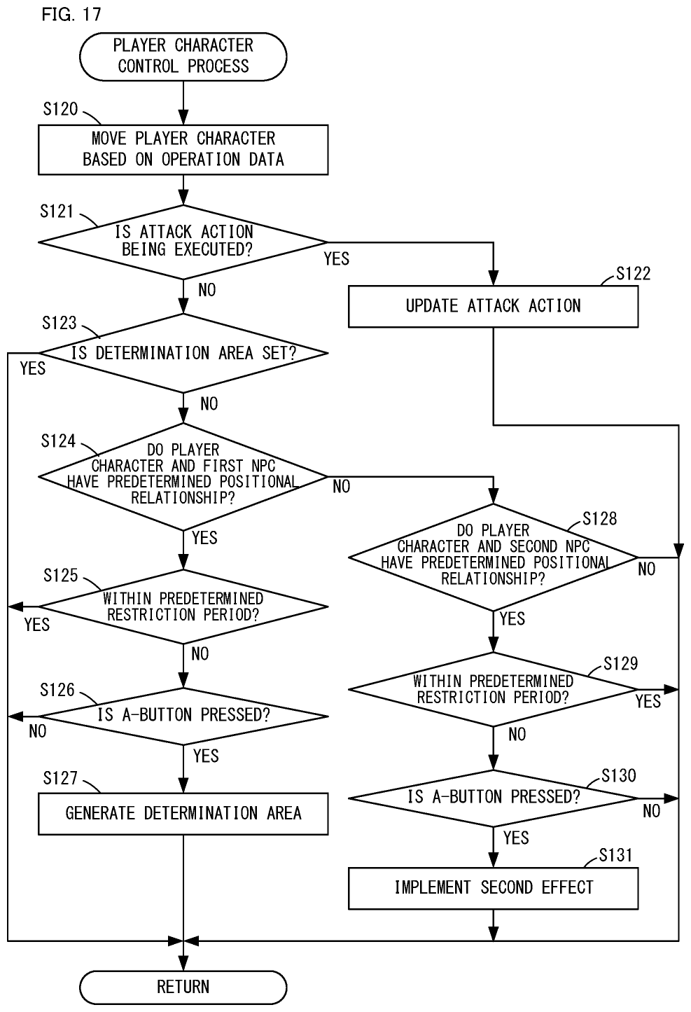

Next, the details of the player character control process in the above step S102 are described. FIG. 17 is a flow chart showing an example of the player character control process in step S102.

As shown in FIG. 17, first, the processor 81 moves the player character 100 in the virtual space based on the operation data (step S120). Here, for example, based on an operation input provided to the left analog stick 32, the processor 81 moves the player character 100 in the virtual space by an amount of movement relating to a single frame.

Next, the processor 81 determines whether or not an attack action is started in the player character attack action process described below and the attack action is being executed (step S121). For example, an execution time is set in advance with respect to each attack action. It is determined whether or not the current time is within the execution time set in advance after the attack action is started.

If the attack action is being executed (step S121: YES), the processor 81 advances the animation of the attack action that is being executed by a single frame (step S122). If the process of step S122 is executed, the processor 81 ends the process shown in FIG. 17.

If the attack action is not being executed (step S121: NO), the processor 81 determines whether or not the determination area 120 is set in the virtual space (step S123). Specifically, with reference to the determination area data, the processor 81 determines whether or not the determination area 120 is currently set.

If the determination area 120 is not set (step S123: NO), the processor 81 determines whether or not the player character 100 and the first NPC 110 have a predetermined positional relationship indicating that the player character 100 and the first NPC 110 are close to each other (step S124). Specifically, the processor 81 determines whether or not the distance between the player character 100 and the first NPC 110 is less than a predetermined threshold.

If it is determined that the player character 100 and the first NPC 110 have the predetermined positional relationship (step S124: YES), the processor 81 determines whether or not the current time is within a predetermined restriction period (step S125). The predetermined restriction period is set in accordance with the fact that the lightning 130 is generated in step S170 described below. The predetermined restriction period may be the period from when the lightning 130 is generated to when a certain time (e.g., 10 seconds) elapses. Also if the determination area 120 is erased due to the lapse of the predetermined effective period without the lightning 130 being generated after the determination area 120 is generated (if step S147 described below is performed), the predetermined restriction period may be set. Conversely, if the determination area 120 is erased due to the lapse of the predetermined effective period without the lightning 130 being generated after the determination area 120 is generated, the predetermined restriction period may not be set.

If the current time is not within the predetermined restriction period (step S125: NO), based on the operation data, the processor 81 determines whether or not the A-button is pressed (step S126).

If the A-button is pressed (step S126: YES), the processor 81 generates the determination area 120 in the virtual space (step S127). Specifically, the processor 81 sets the center of the determination area 120 at the position of the first NPC 110 and sets the radius of the determination area 120 to the initial value. The processor 81 also stores, in the determination area data, data indicating that the determination area 120 is currently set.

If the determination is YES in step S123, or if the determination is YES in step S125, or if the determination is NO in step S126, or if the process of step S127 is executed, the processor 81 ends the process shown in FIG. 17.

If, on the other hand, it is determined that the player character 100 and the first NPC 110 do not have the predetermined positional relationship (step S124: NO), the processor 81 determines whether or not the player character 100 and the second NPC 111 have a predetermined positional relationship indicating that the player character 100 and the second NPC 111 are close to each other (step S128). For example, the processor 81 determines whether or not the distance between the player character 100 and the second NPC 111 is less than a predetermined threshold.

If it is determined that the player character 100 and the second NPC 111 have the predetermined positional relationship (step S128: YES), the processor 81 determines whether or not the current time is within a predetermined restriction period (step S129). The predetermined restriction period in step S129 may be the period from when the second effect associated with the second NPC 111 is implemented to when a certain time elapses.

If the current time is not within the predetermined restriction period (step S129: NO), based on the operation data, the processor 81 determines whether or not the A-button is pressed (step S130).

If the A-button is pressed (step S130: YES), the processor 81 implements the second effect associated with the second NPC 111 (step S131). The second effect is an effect different from the above first effect. The second effect may be an effect related to the properties of the second NPC 111.

If the determination is NO in step S128, or if the determination is YES in step S129, or if the determination is NO in step S130, or if the process of step S131 is executed, the processor 81 ends the process shown in FIG. 17.

(Determination Area Setting Process)

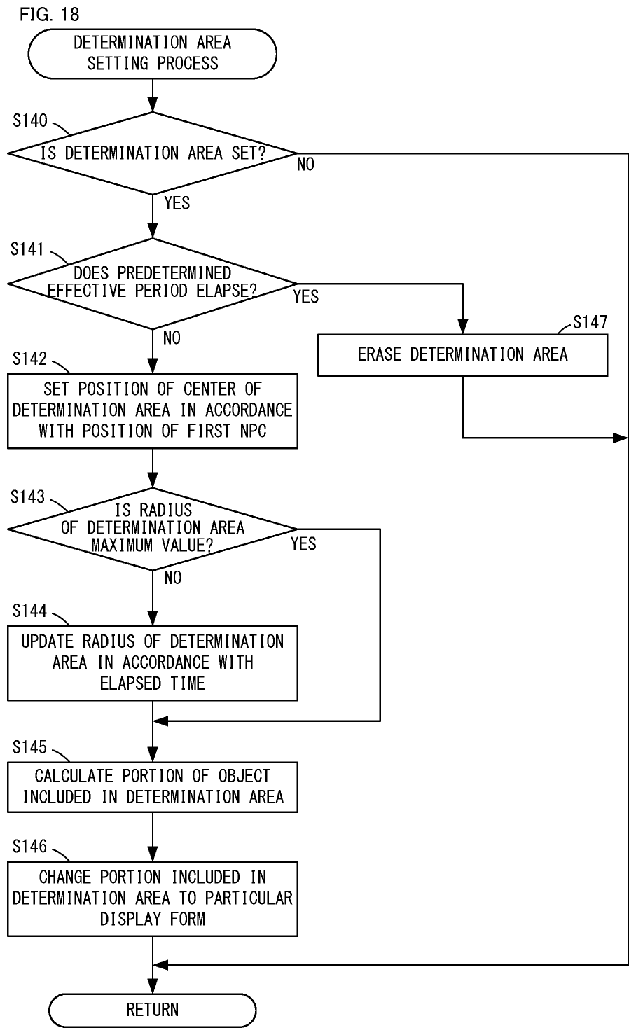

Next, the details of the determination area setting process in the above step S105 are described. FIG. 18 is a flow chart showing an example of the determination area setting process in step S105.

First, the processor 81 determines whether or not the determination area 120 is set (step S140). Specifically, with reference to the determination area data, the processor 81 determines whether or not the determination area 120 is currently set.

If the determination area 120 is set (step S140: YES), the processor 81 determines whether or not the predetermined effective period elapses (step S141). For example, the processor 81 determines whether or not a certain time (e.g., 10 seconds) elapses after the determination area 120 is generated in step S127.

If the predetermined effective period does not elapse after the determination area 120 is generated (step S141: NO), the processor 81 sets the position of the center of the determination area 120 in accordance with the position of the first NPC 110 (step S142). Here, the position of the center of the determination area 120 is set at the position of the first NPC 110. For example, if the position of the first NPC 110 changes from the time when the determination area 120 is generated in step S127, the position of the center of the determination area 120 is also changed.

Next, the processor 81 determines whether or not the radius of the determination area 120 is the maximum value (step S143). The processor 81 may determine whether or not a predetermined time (e.g., 5 seconds) elapses from the time when the determination area 120 is generated in step S127.

If it is determined that the radius of the determination area 120 is not the maximum value (step S143: NO), the processor 81 updates the radius of the determination area 120 in accordance with the time elapsed from the time when the determination area 120 is generated in step S127 (step S144). For example, the processor 81 increases the radius of the determination area 120 by a predetermined length so that the determination area 120 expands at a constant speed. Consequently, the determination area 120 is expanded in accordance with the lapse of time. The speed at which the determination area 120 expands may not be constant.

If the determination is YES in step S143, or if the process of step S144 is executed, the processor 81 calculates a portion of an object included in the determination area 120 (step S145). Specifically, the processor 81 calculates a portion of the surface of each object placed in the virtual space (a ground object, an enemy character 200, an obstacle object as an obstacle to the player character 100, or the like) that is included inside the determination area 120.

Next, the processor 81 changes the portion of the object included in the determination area 120 that is calculated in step S145 to a particular display form (step S146). Consequently, the portion of the surface of each object that is included inside the determination area 120 is changed to the particular display form (e.g., a color indicating that the determination area 120 is set).

If, on the other hand, the predetermined effective period elapses after the determination area 120 is generated (step S141: YES), the processor 81 erases the determination area 120 (step S147). Specifically, the processor 81 sets the radius of the determination area 120 to “0” and also stores, in the determination area data, data indicating that the determination area 120 is not set. Consequently, the display forms of the objects also return from the particular display forms to the normal forms.

If the determination is NO in step S140, or if the process of step S146 is executed, or if the process of step S147 is executed, the processor 81 ends the process shown in FIG. 18.

(Player Character Attack Action Process)

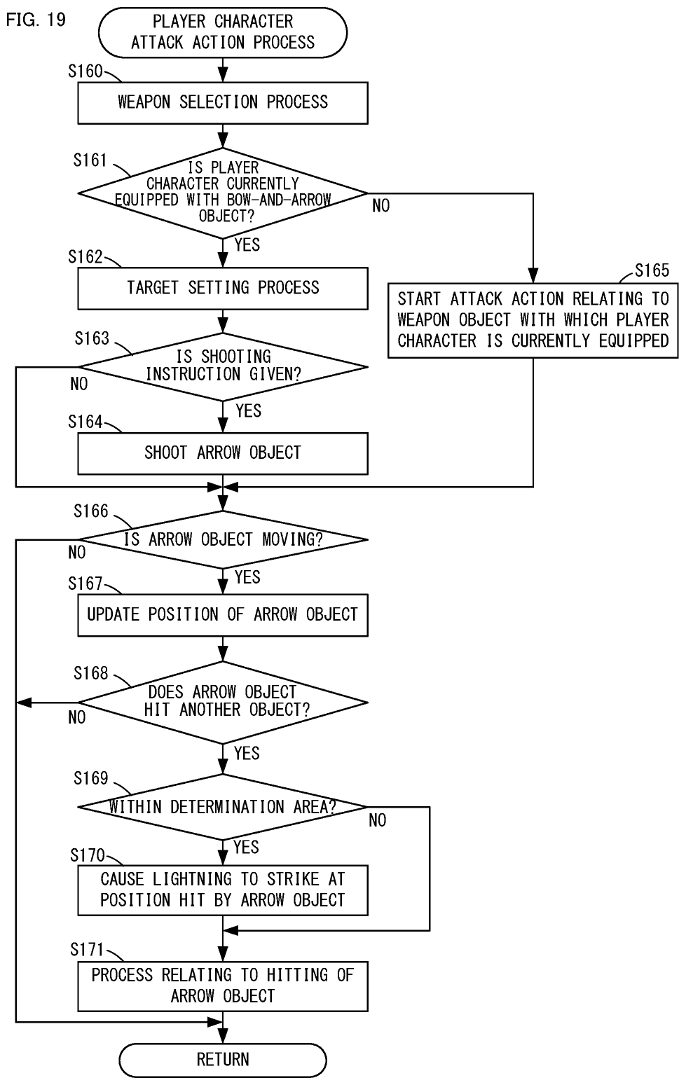

Next, the details of the player character attack action process in the above step S106 are described. FIG. 19 is a flow chart showing an example of the player character attack action process in step S106.

First, the processor 81 performs a weapon selection process (step S160). Here, based on the operation data, the processor 81 determines whether or not a weapon selection operation is performed by the player. If it is determined that a weapon selection operation is performed by the player, based on the operation data, the processor 81 selects a weapon object with which the player character 100 is equipped, and stores data indicating the selected weapon object as the equipment data. Consequently, the player character 100 is equipped with any of the plurality of weapon objects owned by the player character 100.

Next, the processor 81 determines whether or not the player character 100 is currently equipped with the bow-and-arrow object (step S161).

If it is determined that the player character 100 is currently equipped with the bow-and-arrow object (step S161: YES), the processor 81 performs a target setting process (step S162). Here, based on the operation data, the processor 81 determines whether or not to display the target image 102. If it is determined that the target image 102 is to be displayed, the target image 102 is displayed on the screen. For example, if the ZR-button is pressed, the processor 81 displays the target image 102 on the screen. The processor 81 also changes the position of the target image 102, for example, in accordance with an operation input to the right analog stick 52.

Next, based on the operation data, the processor 81 determines whether or not a shooting instruction is given (step S163). Specifically, in the state where the target image 102 is displayed, based on the operation data, the processor 81 determines whether or not a shooting instruction is given.

If it is determined that a shooting instruction is given (step S163: YES), the processor 81 shoots the arrow object 101 to the virtual space (step S164). Specifically, the processor 81 causes the player character 100 to start an attack action regarding the shooting of the arrow object 101 and also shoots the arrow object 101 from the position of the player character 100 to a position in the virtual space indicated by the target image 102. Consequently, the arrow object 101 starts moving in the virtual space.

If, on the other hand, the player character 100 is not currently equipped with the bow-and-arrow object (step S161: NO), the processor 81 starts an attack action relating to a weapon object with which the player character 100 is currently equipped (step S165). During a plurality of frames from the start of the attack action, the animation of the player character 100 regarding the attack action is displayed. For example, if the player character 100 is currently equipped with the sword object, based on the operation data, the processor 81 determines whether or not an instruction to perform an attack action is given. If an instruction to perform an attack action is given, the processor 81 causes the player character 100 to start an attack action using the sword object.

If the determination is NO in step S163, or if the process of step S164 is executed, or if the process of step S165 is executed, the processor 81 determines whether or not the arrow object 101 is moving in the virtual space (step S166). Here, it is determined whether or not the arrow object 101 shot in step S164 is moving in the virtual space.

If the arrow object 101 is moving in the virtual space (step S166: YES), the processor 81 updates the position of the arrow object 101 (step S167). The processor 81 updates the position of the arrow object 101 based on the current position and the velocity (the shooting direction and the velocity) of the arrow object 101.

Next, the processor 81 determines whether or not the arrow object 101 hits another object in the virtual space (step S168). Specifically, based on the position of the arrow object 101 and the position and the shape of another object in the virtual space, the processor 81 makes a hitting determination between the arrow object 101 and another object. For example, the processor 81 determines whether or not the arrow object 101 hits the ground object 300, whether or not the arrow object 101 hits an enemy character 200, or whether or not the arrow object 101 hits an obstacle object in the virtual space.

If it is determined that the arrow object 101 hits an object in the virtual space (step S168: YES), the processor 81 determines whether or not the position hit by the arrow object 101 is within the determination area 120 (step S169).

If the position hit by the arrow object 101 is within the determination area 120 (step S169: YES), the processor 81 causes the lightning 130 to strike at the position hit by the arrow object 101 (step S170). Consequently, the effect of the lightning 130 is generated in a predetermined range centered on the position hit by the arrow object 101. For example, if the lightning 130 directly hits an enemy character 200, great damage is caused on the enemy character 200. Even if the lightning 130 does not directly hit an enemy character 200, but the enemy character 200 is present within a predetermined range from the position hit by the lightning 130, damage is caused on the enemy character 200. If the lightning 130 directly hits a predetermined obstacle object, or if an obstacle object is present within a predetermined range from the position hit by the lightning 130, the obstacle object is destroyed (erased).

If the determination is NO in step S169, or if the process of step S170 is performed, the processor 81 performs a process relating to the hitting of the arrow object 101 (step S171). For example, if the arrow object 101 hits an enemy character 200, damage is caused on the enemy character 200. Damage on the enemy character 200 due to the fact that the lightning 130 hits the enemy character 200 is greater than damage on the enemy character 200 due to the fact that the arrow object 101 hits the enemy character 200.

If the determination is NO in step S166, or if the determination is NO in step S168, or if the process of step S171 is executed, the processor 81 ends the process shown in FIG. 19.

(Variations)

While the exemplary embodiment has been described above, the exemplary embodiment is merely an example and may be modified as follows, for example.

For example, in the above exemplary embodiment, in accordance with the fact that the player character 100 moves close to the first NPC 110 and the A-button is pressed, the spherical determination area 120 is set at the position of the first NPC 110. The shape of the determination area 120 is not limited to a sphere, and may be any shape such as a cuboid, a cube, or an ellipsoid. The determination area is not limited to a three-dimensional shape, and may be a two-dimensional shape. For example, the determination area may be set on the surface of an object in the virtual space. For example, the determination area may be generated on the terrain object 300 and at the position of the first NPC 110, and may be expanded in accordance with the lapse of time.

In the above exemplary embodiment, the determination area 120 is set at the position of the first NPC 110 and moves in accordance with the movement of the first NPC 110. In another exemplary embodiment, the determination area 120 may be configured so that after the determination area 120 is set at the position of the first NPC 110, the determination area 120 does not to move. Specifically, in the above step S127, the determination area 120 is generated at the position of the first NPC 110, and the position is stored. Then, the determination area 120 is expanded in accordance with the lapse of time, but even if the position of the first NPC 110 changes, the center of the determination area 120 is fixed to the position at the time when the determination area 120 is generated in step S127.

In the above exemplary embodiment, the player character 100 makes the attack of flying the arrow object 101 to the virtual space as an example of the remote attack. The remote attack is not limited to an attack using the bow-and-arrow object. For example, as the remote attack, the attack of flying a bullet using a gun, the attack of flying a bullet of a cannon, the attack of throwing a stone, or the like may be made.

In the above exemplary embodiment, if the predetermined effective period elapses, the determination area 120 is erased. In another exemplary embodiment, if the determination area 120 is expanded to a predetermined size, the determination area 120 may be erased.

In another exemplary embodiment, if the predetermined effective period elapses after the determination area 120 is generated, or if the determination area 120 is expanded to the predetermined size, the determination area 120 may not be erased. That is, the determination area 120 may not be erased until the lightning 130 is generated.

In another exemplary embodiment, the determination area 120 may be maintained without being erased even after the lightning 130 is generated, and if the predetermined effective period elapses, or if the determination area 120 is expanded to the predetermined size, the determination area 120 may be erased.

In the above exemplary embodiment, if the remote attack hits an object in the determination area 120, the lightning 130 is generated, and then, even if the predetermined instruction (the player character 100 comes close to the first NPC 110 and the A-button is pressed) is given, the determination area 120 is not generated until the predetermined restriction period elapses. In another exemplary embodiment, the determination area 120 may not be generated by performing control so that the predetermined instruction is prohibited until the predetermined restriction period elapses after the lightning 130 is generated. For example, control may be performed so that the player character 100 cannot come close to the first NPC 110 until the predetermined restriction period elapses after the lightning 130 is generated.

If the lightning 130 is generated and the determination area 120 is erased, the predetermined restriction period may be set, and if the determination area 120 is erased in accordance with the lapse of the predetermined effective period, the predetermined restriction period may not be set. That is, after the determination area 120 is generated, and if the determination area 120 is erased in according to the lapse of the predetermined effective period without the lightning 130 being generated, the predetermined restriction period may not be provided, and the determination area 120 may be able to be immediately generated again.

After the lightning 130 is generated and the determination area 120 is erased, the generation of the determination area 120 may be restricted until a first restriction period elapses. After the determination area 120 is erased in accordance with the lapse of the predetermined effective period, the generation of the determination area 120 may be restricted until a second restriction period shorter (or longer) than the first restriction period elapses.

In the above exemplary embodiment, the determination area 120 is not generated within the predetermined restriction period. In another exemplary embodiment, the generation of the determination area 120 may be restricted within the predetermined restriction period. For example, the determination area 120 is generated even within the predetermined restriction period, but the speed of the expansion of the determination area 120 within the predetermined restriction period may be slower than the expansion speed outside the predetermined restriction period.

In the above exemplary embodiment, if the remote attack hits an object in the determination area 120, the lightning 130 is generated. The first effect produced in a case where the remote attack hits an object in the determination area 120 is merely an example, and any other effect may be produced.

In the above exemplary embodiment, if the remote attack hits an object in the determination area 120, the first effect (e.g., the lightning 130) is produced at the position hit by the remote attack. The place where the first effect is generated may not be at exactly the same position as the position hit by the remote attack. For example, the first effect may be produced in a predetermined range including the position hit by the remote attack.

The operations for performing the above processes are merely examples, and may be replaced with other operations.

In the above exemplary embodiment, a game that progresses while the player controls the player character 100 to defeat the enemy characters 200 automatically controlled by the processor 81 is assumed. In another exemplary embodiment, for example, a game where players fight with each other while controlling player characters of the players may be performed. In this case, each player character comes close to the above first NPC 110, generates the determination area 120, and hits an object in the determination area 120 with the remote attack, and thereby can produce the first effect.

The processes shown in the above flow charts are merely illustrative, and the order and the contents of the processes, and the like may be appropriately changed.

The configuration of the hardware that performs the above game is merely an example, and the above game processing may be performed by any other hardware. For example, the above game processing may be executed by any information processing apparatus such as a personal computer, a tablet terminal, a smartphone, or a server on the Internet. The above game processing may also be executed by an information processing apparatus including a plurality of apparatuses.

The configurations of the above exemplary embodiment and its variations can be optionally combined together unless they contradict each other. Further, the above description is merely an example of the exemplary embodiment, and may be improved and modified in various manners other than the above.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. A non-transitory computer-readable storage medium having stored therein instructions that, when executed, cause a processor of an information processing apparatus to execute game processing comprising:
controlling a player character to at least move based on a first operation input and make a remote attack based on a second operation input in a virtual space;
generating a determination area in the virtual space in accordance with giving of a predetermined instruction based on an operation input and expanding the determination area in accordance with a lapse of time; and
if the remote attack hits an object in the virtual space in the determination area, producing a first effect at a place hit by the remote attack.

2. The non-transitory computer-readable storage medium according to claim 1, wherein
the game processing further comprises automatically controlling a first non-player character in the virtual space, and
the predetermined instruction is provision of a third operation input when the player character and the first non-player character have a predetermined positional relationship.

3. The non-transitory computer-readable storage medium according to claim 2, wherein
the determination area is generated at a position of the first non-player character.

4. The non-transitory computer-readable storage medium according to claim 3, wherein
the determination area is expanded about the position of the first non-player character.

5. The non-transitory computer-readable storage medium according to claim 1, wherein
the game processing further comprises, if the first effect is produced, erasing the determination area.

6. The non-transitory computer-readable storage medium according to claim 5, wherein
the game processing further comprises, if a predetermined time elapses after the determination area is generated, or if the determination area is expanded to a predetermined size, erasing the determination area.

7. The non-transitory computer-readable storage medium according to claim 5, wherein
the game processing further comprises restricting the generation of the determination area until a predetermined time elapses after the determination area is erased.

8. The non-transitory computer-readable storage medium according to claim 1, wherein
the game processing further comprises performing display indicating a range of the determination area.

9. The non-transitory computer-readable storage medium according to claim 1, wherein
the first effect is an effect of causing damage on an enemy object placed at the place hit by the remote attack, or destroying an obstacle object placed at the place hit by the remote attack.

10. The non-transitory computer-readable storage medium according to claim 2, wherein
the game processing further comprises:
automatically moving a second non-player character in the virtual space; and
if the player character and the second non-player character have a predetermined positional relationship, producing a second effect in accordance with the second operation input.

11. An information processing system comprising:
a processor; and
a storage medium storing executable instructions that, when executed, cause the processor to execute game processing comprising:
controlling a player character to at least move based on a first operation input and make a remote attack based on a second operation input in a virtual space;
generating a determination area in the virtual space in accordance with giving of a predetermined instruction based on an operation input and expanding the determination area in accordance with a lapse of time; and
if the remote attack hits an object in the virtual space in the determination area, producing a first effect at a place hit by the remote attack.

12. The information processing system according to claim 11, wherein
the game processing further comprises automatically controlling a first non-player character in the virtual space, and
the predetermined instruction is provision of a third operation input when the player character and the first non-player character have a predetermined positional relationship.

13. The information processing system according to claim 12, wherein
the determination area is generated at a position of the first non-player character.

14. The information processing system according to claim 13, wherein
the determination area is expanded about the position of the first non-player character.

15. The information processing system according to claim 11, wherein
the game processing further comprises, if the first effect is produced, erasing the determination area.

16. The information processing system according to claim 15, wherein
the game processing further comprises, if a predetermined time elapses after the determination area is generated, or if the determination area is expanded to a predetermined size, erasing the determination area.

17. The information processing system according to claim 15, wherein
the game processing further comprises restricting the generation of the determination area until a predetermined time elapses after the determination area is erased.

18. The information processing system according to claim 11, wherein
the game processing further comprises performing display indicating a range of the determination area.

19. The information processing system according to claim 11, wherein
the first effect is an effect of causing damage on an enemy object placed at the place hit by the remote attack, or destroying an obstacle object placed at the place hit by the remote attack.

20. The information processing system according to claim 12, wherein
the game processing further comprises:
automatically moving a second non-player character in the virtual space; and
if the player character and the second non-player character have a predetermined positional relationship, producing a second effect in accordance with the second operation input.

21. An information processing apparatus comprising:
a processor; and
a storage medium storing executable instructions that, when executed, cause the processor to execute game processing comprising:
controlling a player character to at least move based on a first operation input and make a remote attack based on a second operation input in a virtual space;
generating a determination area in the virtual space in accordance with giving of a predetermined instruction based on an operation input and expanding the determination area in accordance with a lapse of time; and
if the remote attack hits an object in the virtual space in the determination area, producing a first effect at a place hit by the remote attack.

22. The information processing apparatus according to claim 21, wherein
the game processing further comprises automatically controlling a first non-player character in the virtual space, and
the predetermined instruction is provision of a third operation input when the player character and the first non-player character have a predetermined positional relationship.

23. An information processing method performed by an information processing system, the information processing method comprising:
controlling a player character to at least move based on a first operation input and make a remote attack based on a second operation input in a virtual space;
generating a determination area in the virtual space in accordance with giving of a predetermined instruction based on an operation input and expanding the determination area in accordance with a lapse of time; and
if the remote attack hits an object in the virtual space in the determination area, producing a first effect at a place hit by the remote attack.

24. The information processing method according to claim 23, further comprising automatically controlling a first non-player character in the virtual space, wherein
the predetermined instruction is provision of a third operation input when the player character and the first non-player character have a predetermined positional relationship.
